(19) United States
(12) Patent Application Publication
(10) Pub. No.: US 2012/0170666 A1
(43) Pub. Date: Jul. 5, 2012

(54) POWER OPTIMIZATION FOR SPECIAL MEDIA PLAYBACK SCENARIOS

(76) Inventors: Sankaranarayanan Venkatasubramanian, Tirunelveli (IN); Sailesh Rathi, Bangalore (IN)

(21) Appl. No.: 12/981,103

(22) Filed: Dec. 29, 2010

(51) Int. Cl. H04N 7/26

(52) U.S. Cl. 375/240.25; 375/E07.027

(57) ABSTRACT

A method, system, apparatus, and computer program product for optimizing power consumption in special media playback scenarios. The method includes identifying a scenario where decoding of a first portion of a multimedia stream can be interrupted; and interrupting the decoding of the first portion of the multimedia stream while continuing to decode a second portion of the multimedia stream. The first portion may be a video stream and the second portion may be an audio stream, and the scenario may include a playback window for the video stream being hidden. The first portion may be an audio stream and the second portion may be a video stream, and the scenario may include the audio stream being muted. The method may further include determining that the scenario has changed and resuming decoding of the first portion of the multimedia stream.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### TECHNICAL FIELD

The present disclosure relates generally to power optimization in computing devices.

### BACKGROUND

With the proliferation of mobile devices in today's society, applications running in mobile computing environments are increasing in number and sophistication. Users commonly watch television and/or movies as well as listen to music on their mobile devices, all applications that can require a substantial amount of power. With the limited battery life of many mobile devices and the high power demands of multimedia applications, a substantial amount of the power used by the mobile device is consumed by multimedia applications.

### BRIEF DESCRIPTION OF THE DRAWINGS

FIG. 1 is a block diagram of a system configured to enable power optimization for special media playback scenarios in accordance with one embodiment of the invention.

FIG. 2 is a media pipeline showing data flows between components of the system of FIG. 1 during a normal playback scenario.

FIG. 3 is a media pipeline showing data flows between components of the system of FIG. 1 during a playback scenario where the video playback application is overlaid by another application in accordance with one embodiment of the invention.

FIG. 4 is a media pipeline showing data flows between components of the system of FIG. 1 during a playback scenario where the audio output is muted in accordance with one embodiment of the invention.

FIG. 5 is a sequence diagram showing interaction between components of the system of FIG. 1 during a normal playback scenario.

FIG. 6 is a sequence diagram showing interaction between components of the system of FIG. 1 during a playback scenario where the video playback application is overlapped by another application in accordance with one embodiment of the invention.

FIG. 7 is a sequence diagram showing interaction between components of the system of FIG. 1 during a playback scenario where the audio output is muted in accordance with one embodiment of the invention.

FIG. 8 is a sequence diagram showing interaction between components of the system of FIG. 1 during a playback scenario where the audio output is muted in accordance with another embodiment of the invention.

### DETAILED DESCRIPTION

Embodiments of the present invention may provide a method, apparatus, system, and computer program product for optimizing power consumption during special media playback scenarios. In one embodiment, the method includes identifying a scenario where decoding of a first portion of a multimedia stream can be interrupted; and interrupting the decoding of the first portion of the multimedia stream while continuing to decode a second portion of the multimedia stream. The first portion may be a video stream and the second portion may be an audio stream, and the scenario may include a playback window for the video stream being hidden. The first portion may be an audio stream and the second portion may be a video stream, and the scenario may include the audio stream being muted. The method may further include determining that the scenario has changed and resuming decoding of the first portion of the multimedia stream. The method may further include identifying a first frame currently being decoded in the second portion of the multimedia stream; identifying a second frame in the first portion of the multimedia stream, the second frame corresponding to the first frame; and resuming rendering of the first portion of the multimedia stream with the second frame.

Reference in the specification to “one embodiment” or “an embodiment” of the present invention means that a particular feature, structure or characteristic described in connection with the embodiment is included in at least one embodiment of the invention. Thus, the appearances of the phrases “in one embodiment,” “according to one embodiment” or the like appearing in various places throughout the specification are not necessarily all referring to the same embodiment.

For purposes of explanation, specific configurations and details are set forth in order to provide a thorough understanding of the present invention. However, it will be apparent to one of ordinary skill in the art that embodiments of the present invention may be practiced without the specific details presented herein. Furthermore, well-known features may be omitted or simplified in order not to obscure the present invention. Various examples may be given throughout this description. These are merely descriptions of specific embodiments of the invention. The scope of the invention is not limited to the examples given.

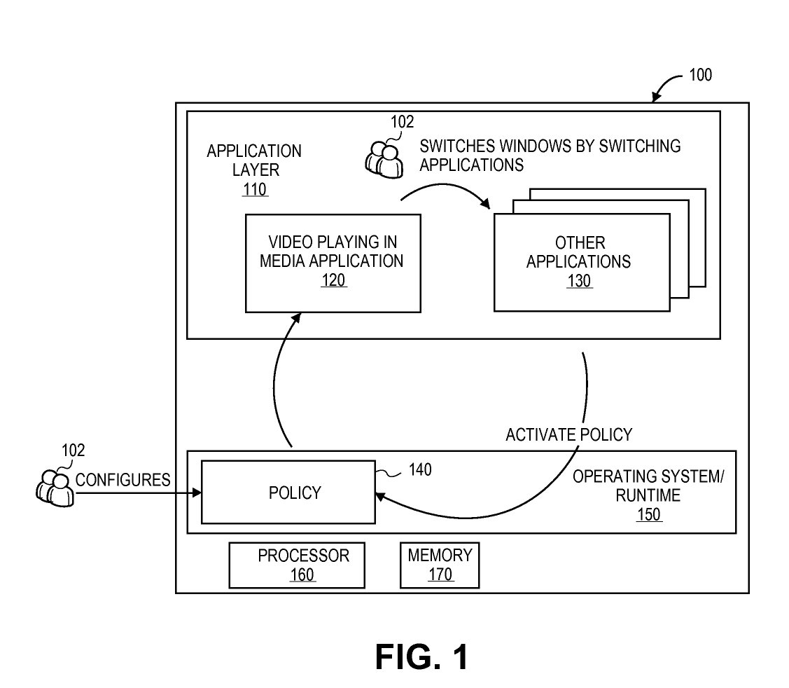

FIG. 1 is a block diagram of a system configured to enable power optimization for special media playback scenarios in accordance with one embodiment of the invention. System 100 includes a software environment having an application layer 110 and an operating system/runtime layer 150 and a hardware environment including a processor 160 and a memory 170. A user 102 of the system uses applications running on processor 160 in application layer 110, such as media application 120 and other applications 130. User 102 may shift focus from one application to another, thereby causing the active application to overlay an inactive application. For example, user 102 may play a video using media application 120, but make a word processing application active, thereby hiding the video application. User 102 may choose to continue to listen to the audio stream while working in the word processing application. In a normal playback scenario, the video stream would continue to be decoded along with the audio stream even though display of the video stream is inactive.

In the embodiment shown in FIG. 1, this playback scenario where the video display is overlaid by another application can be detected and used to optimize power consumption in system 100. Operating system/runtime 150 detects scenarios where power consumption can be optimized. Policy data store 140 stores power optimization parameters that are configurable by user 102. One example of a power optimization parameter is an amount of time that a video playback application is overlaid by another application before switching to a power conservation mode that interrupts video decoding. For example, if the video playback application is overlaid by another application for 10 seconds, decoding of the video stream may be interrupted to save power. Another example of a power optimization parameter is an amount of time that audio is muted before switching to a power conservation mode that interrupts audio decoding.

When operating system/runtime 150 detects a scenario where power consumption can be optimized, such as a video playback application being overlaid by another application, or muting of an audio stream, operating system/runtime 150 checks the policy data store 140 to determine whether to activate the policy. If the power optimization parameters of a policy are met, operating system/runtime 150 notifies the media application 120 to interrupt decoding of the applicable audio or video stream. In response to the notification by operating system/runtime 150, media application 120 interrupts decoding of the applicable audio or video stream. In one embodiment, interrupting decoding of the applicable audio or video stream includes turning off bitstream parsing and rendering as well.

Referring to the hardware environment of system 100, processor 160 provides processing power to system 100 and may be a single-core or multi-core processor, and more than one processor may be included in system 100. Processor 160 may be connected to other components of system 100 via one or more system buses, communication pathways or mediums (not shown). Processor 160 runs host applications such as media application 120 and other applications 130 under the control of operating system/runtime layer 150.

System 100 further includes memory devices such as memory 170. These memory devices may include random access memory (RAM) and read-only memory (ROM). For purposes of this disclosure, the term “ROM” may be used in general to refer to non-volatile memory devices such as erasable programmable ROM (EPROM), electrically erasable programmable ROM (EEPROM), flash ROM, flash memory, etc. These memory devices may further include mass storage devices such as integrated drive electronics (IDE) hard drives, and/or other devices or media, such as floppy disks, optical storage, tapes, flash memory, memory sticks, digital video disks, biological storage, etc.

Processor 160 may also be communicatively coupled to additional components, such as a display controller, small computer system interface (SCSI) controllers, network controllers, universal serial bus (USB) controllers, input devices such as a keyboard and mouse, etc. System 100 may also include one or more bridges or hubs, such as a memory controller hub, an input/output (I/O) controller hub, a PCI root bridge, etc., for communicatively coupling various system components. As used herein, the term “bus” may be used to refer to shared communication pathways, as well as point-to-point pathways.

Some components of system 100 may be implemented as adapter cards with interfaces (e.g., a PCI connector) for communicating with a bus. In one embodiment, one or more devices may be implemented as embedded controllers, using components such as programmable or non-programmable logic devices or arrays, application-specific integrated circuits (ASICs), embedded computers, smart cards, and the like.

As used herein, the terms “processing system” and “data processing system” are intended to broadly encompass a single machine, or a system of communicatively coupled machines or devices operating together. Example processing systems include, without limitation, distributed computing systems, supercomputers, high-performance computing systems, computing clusters, mainframe computers, mini-computers, client-server systems, personal computers, workstations, servers, portable computers, laptop computers, tablets, telephones, personal digital assistants (PDAs), handheld devices, entertainment devices such as audio and/or video devices, and other devices for processing or transmitting information.

System 100 may be controlled, at least in part, by input from conventional input devices, such as keyboards, mice, etc., and/or by commands received from another machine, biometric feedback, or other input sources or signals. System 100 may utilize one or more connections to one or more remote data processing systems (not shown), such as through a network controller, a modem, or other communication ports or couplings.

System 100 may be interconnected to other processing systems (not shown) by way of a physical and/or logical network, such as a local area network (LAN), a wide area network (WAN), an intranet, the Internet, etc. Communications involving a network may utilize various wired and/or wireless short range or long range carriers and protocols, including radio frequency (RF), satellite, microwave, Institute of Electrical and Electronics Engineers (IEEE) 802.11, Bluetooth, optical, infrared, cable, laser, etc.

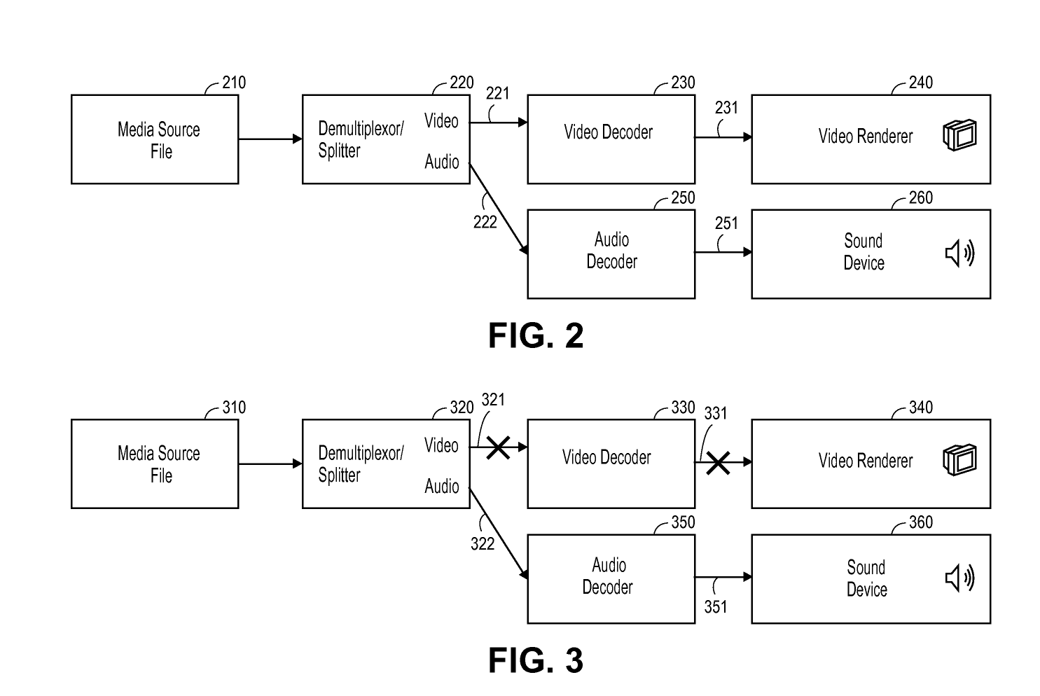

FIG. 2 is a media pipeline showing data flows between components of the media application of FIG. 1 during a normal playback scenario. Media source file 210 represents an input media stream that is received by a demultiplexor/splitter 220 component of media application 120 of FIG. 1. Demultiplexor/splitter 220 splits the input media stream into a video stream 221 and an audio stream 222. Video stream 221 is provided as input to a video decoder 230, which parses and decodes the bit stream and provides the decoded video bit stream 231 to video renderer 240, which renders the video output. From demultiplexor/splitter 220, audio stream 222 is provided as input to an audio decoder 250. The decoded output audio stream 251 is provided to a sound device 260.

FIG. 3 is a media pipeline showing data flows between components of the media application of FIG. 1 during a playback scenario where the video playback application is overlapped by another application in accordance with one embodiment of the invention. Media source file 310 represents an input media stream that is received by a demultiplexor/splitter 320 component of media application 120 of FIG. 1. Demultiplexor/splitter 320 splits the input media stream into a video stream 321 and an audio stream 322. However, because the video playback application is overlaid by another application, demultiplexor/splitter 320 does not provide the video stream 321 to video decoder 330, and thus the video stream does not reach video renderer 340, so no video output is rendered. During the time that no video is being decoded, substantial power savings are possible by eliminating the CPU cycles for decoding and rendering the video. Although the video stream is not decoded, demultiplexor/splitter 320 continues to provide the audio stream 322 to an audio decoder 350. The decoded output audio stream 351 is provided to a sound device 360.

A simulation of the video playback application being overlaid by another application was performed in a WINDOWS® Vista system running INTEL® Core2Duo™ 2.0 GHz with 3 GB RAM playing a media stream whose video stream being encoded in MPEG4-Part2 and audio stream being encoded in MP3. A one-minute playback scenario with both audio and video decoding was compared to a one-minute playback scenario with only audio decoding (where the video application was overlaid by another application). A 42% reduction in clocks per instruction retired (CPI) was found, which produced proportional savings in power consumed.

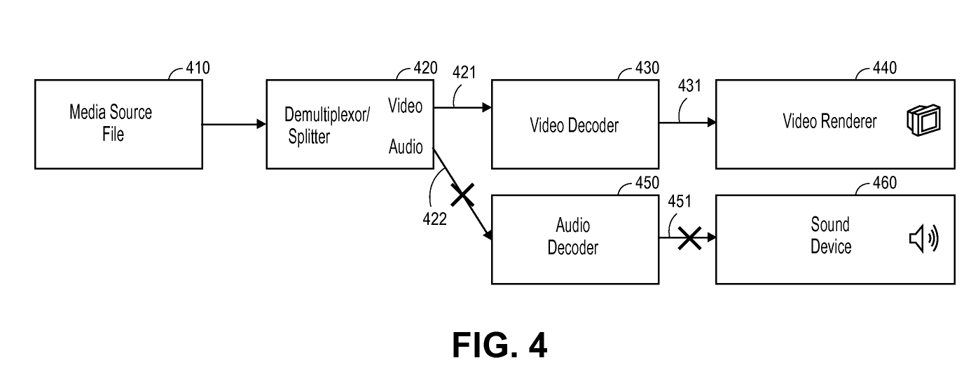

FIG. 4 is a media pipeline showing data flows between components of the media application of FIG. 1 during a playback scenario where the audio output is muted in accordance with one embodiment of the invention. Media source file 410 represents an input media stream that is received by a demultiplexor/splitter 420 component of media application 120 of FIG. 1. Demultiplexor/splitter 420 splits the input media stream into a video stream 421 and an audio stream 422. The video stream 421 is provided as input to a video decoder 430, which parses and decodes the bit stream and provides the decoded bit stream 431 to video renderer 440, which renders the video output. However, demultiplexor/splitter 420 does not provide audio stream 422 as input to audio decoder 450, and no output audio stream is provided to sound device 460. Substantial power savings can be achieved by bypassing the CPU cycles to decode and render audio output.

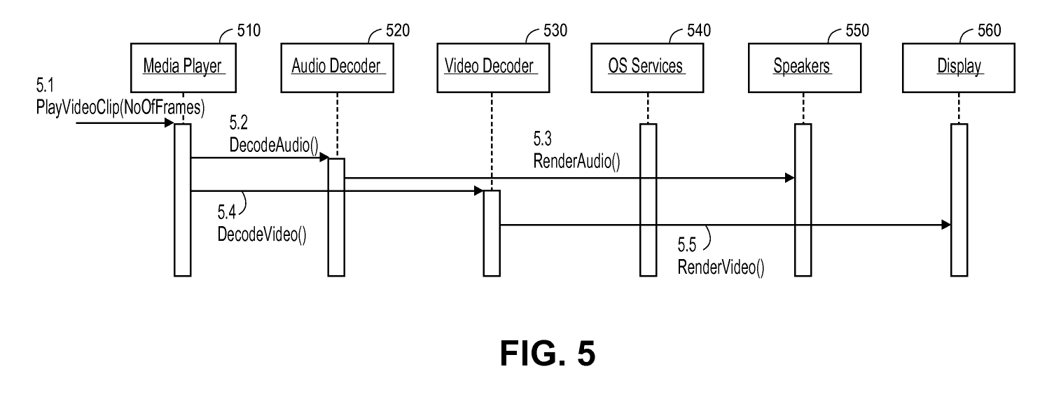

FIG. 5 is a sequence diagram showing interaction between components of the media application of FIG. 1 during a normal playback scenario. In action 5.1, an input media stream is provided to media player 510 In response to receiving the video clip, media player 510 calls audio decoder 520, providing a bit stream in action 5.2. In action 5.3, audio decoder 520 decodes the bit stream and renders the audio stream output on speakers 550. In action 5.4, media player 510 calls video decoder 530, providing the video stream. In action 5.5, video decoder 530 decodes and renders the video output stream on display 560. During all of this activity, OS services 540 monitors for a scenario in which power consumption can be optimized when the policy is active. The steps in FIG. 5 are repeated for all frames in the Video clip. Audio and video decoding and rendering actions may happen in parallel; e.g., actions 5.2 and 5.3 may occur in parallel with actions 5.4 and 5.5. In addition, some audio or video frames may be decoded at the same time that other audio or video frames are being rendered; e.g., some frames may be decoded in step 5.2 (or 5.4) at the same time that other frames are being rendered in step 5.3 (or 5.5).

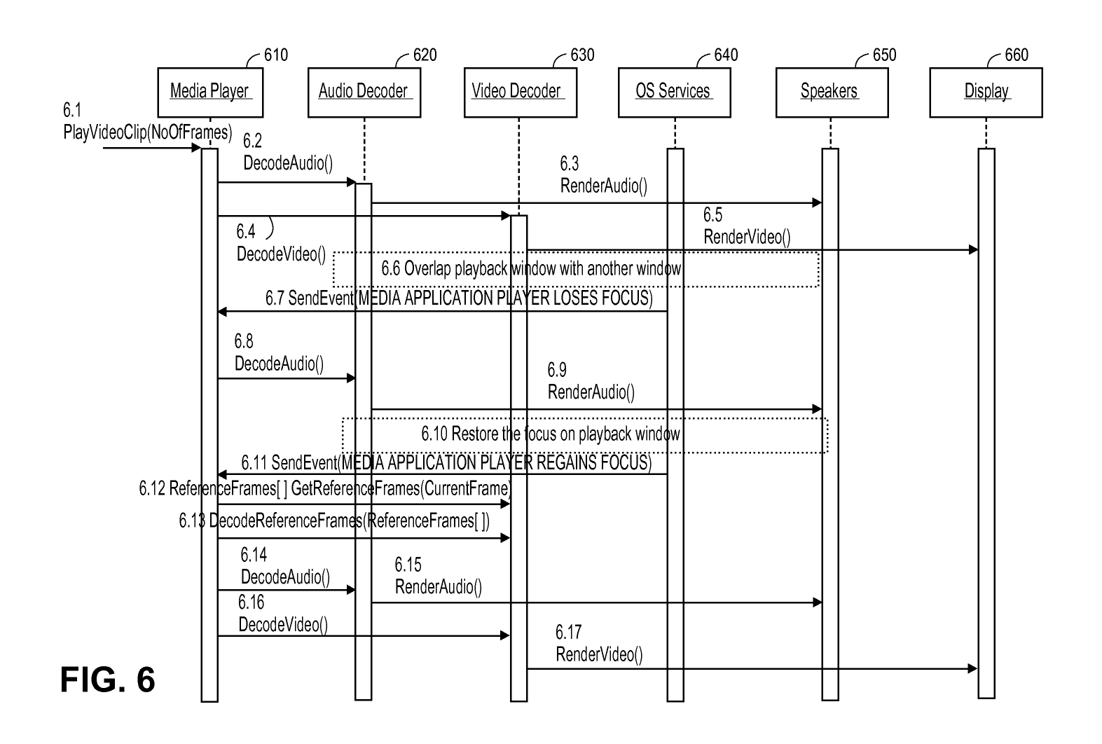

FIG. 6 is a sequence diagram showing interaction between components of the media application of FIG. 1 during a playback scenario where the video playback application is overlaid by another application in accordance with one embodiment of the invention. In action 6.1, an input media stream is provided to media player 610 In response to receiving the video clip, media player 610 calls audio decoder 620, providing a bit stream in action 6.2. In action 6.3, audio decoder 620 decodes the bit stream and renders the audio stream output on speakers 650. In action 6.4, media player 610 calls video decoder 630, providing the video stream. In action 6.5, video decoder 630 decodes and renders the video output stream on display 660. During all of this activity, OS services 640 monitors for a scenario in which power consumption can be optimized. Up until this point, the normal playback scenario has been followed as no opportunities to optimize power consumption have occurred. The steps in FIG. 6 are performed for all frames in the media clip. The audio and video steps in the figure happen in parallel.

In action 6.6, OS services 640 identifies a scenario where the video playback application has been overlaid by another application. In action 6.7, OS services 640 sends an event PLAYBACK_APPLICATION_LOST_FOCUS to media player 610. In response to receiving the event, media player 610 interrupts decoding of the video stream to enter a power optimization mode. In action 6.8, media player 610 continues to send the audio stream to audio decoder 620 for decoding, and in action 6.9, audio decoder 620 renders the output audio stream on speakers 650. Audio only playback continues until OS services 640 identifies a scenario where video decoding is again needed.

In action 6.10, the user restores the focus on the video playback application. In response to detecting this event, in action 6.11, OS services 640 sends an event PLAYBACK_APPLICATION_FOCUS_REGAINED to media player 610. In response to receiving the event, media player 610 identifies the current frame being played in audio output by calling the GetReferenceFrames function with the CurrentFrame parameter. The currently active audio frame is used to identify the corresponding video frame and the associated reference frames for decoding the current video frame to place the video playback in synchronization with the audio playback. In action 6.13, all of the reference frames are sent from media player 610 to video decoder 630 for decoding. All of the reference frames are decoded in order to identify the reference frame corresponding to the current audio frame. Only the frames starting from current video frame are displayed. Even though all of the reference frames must be decoded, only a limited number of reference frames are available. For example, under the H.264 standard, a maximum of 16 reference frames are available, such that a video clip running at 24 frames per second would require less than one second to decode the reference frames.

In action 6.14, now that the audio and video streams are synchronized, normal playback resumes with the video playback application focused and non-muted audio. In action 6.14, media player 610 provides the audio stream to audio decoder 620, which decodes and renders the audio stream on speakers 650 in action 6.15. In action 6.16, media player 610 sends the video stream to video decoder 630 for decoding, and in action 6.17, video decoder 630 decodes and renders the video stream on display 660.

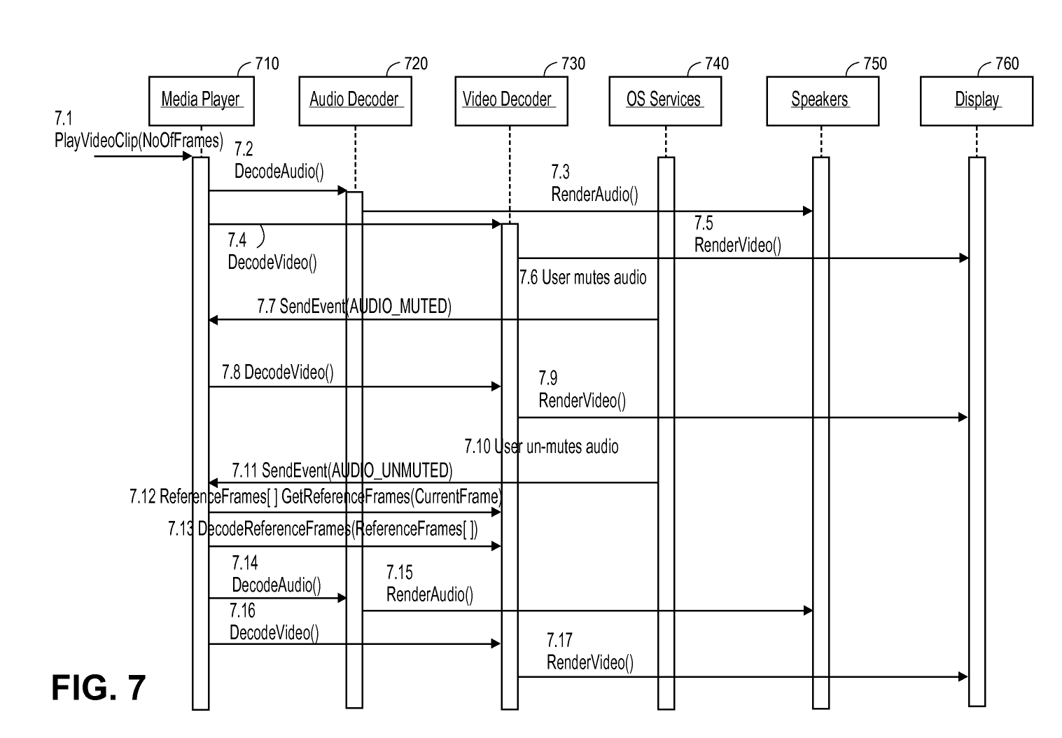

FIG. 7 is a sequence diagram showing interaction between components of the media application of FIG. 1 during a playback scenario where the audio output is muted in accordance with one embodiment of the invention. In action 7.1, an input media stream is provided to media player 710 via a command PlayVideoClip(NoOfFrames). In response to receiving the video clip, media player 710 calls audio decoder 720, providing a bit stream in action 7.2. In action 7.3, audio decoder 720 decodes the bit stream and renders the audio stream output on speakers 750. In action 7.4, media player 710 calls video decoder 730, providing the video stream. In action 7.5, video decoder 730 decodes and renders the video output stream on display 760. During all of this activity, OS services 740 monitors for a scenario in which power consumption can be optimized. Up until this point, the normal playback scenario has been followed as no opportunities to optimize power consumption have occurred.

In action 7.6, OS services 740 identifies a scenario where the audio playback has been muted. In action 7.7, OS services 740 sends an event AUDIO_MUTED to media player 710. In response to receiving the event, media player 710 interrupts decoding of the audio stream to enter a power optimization mode. In action 7.8, media player 710 continues to send the video stream to video decoder 730 for decoding, and in action 7.9, video decoder 730 renders the output video stream on display 760. Video only playback continues until OS services 740 identifies a scenario where audio decoding is again needed.

In action 7.10, the user un-mutes the audio playback. In response to detecting this event, in action 7.11, OS services 740 sends an event AUDIO_UNMUTED to media player 710. In response to receiving the event, media player 710 identifies the current frame being played in video output by calling the GetReferenceFrames function with the CurrentFrame parameter. The currently active video frame and the time of un-muting the audio is used to identify the corresponding audio reference frames to place the video playback in synchronization with the audio playback. In action 7.13, all of the reference frames are sent from media player 710 to audio decoder 730 for decoding. All of the reference frames are decoded in order to identify the reference frame corresponding to the current audio frame.

In action 7.14, now that the audio and video streams are synchronized, normal playback resumes with the video playback application focused and non-muted audio. In action 7.14, media player 710 provides the audio stream to audio decoder 720, which decodes and renders the audio stream on speakers 750 in action 7.15. In action 7.16, media player 710 sends the video stream to video decoder 730 for decoding, and in action 7.17, video decoder 730 decodes and renders the video stream on display 760.

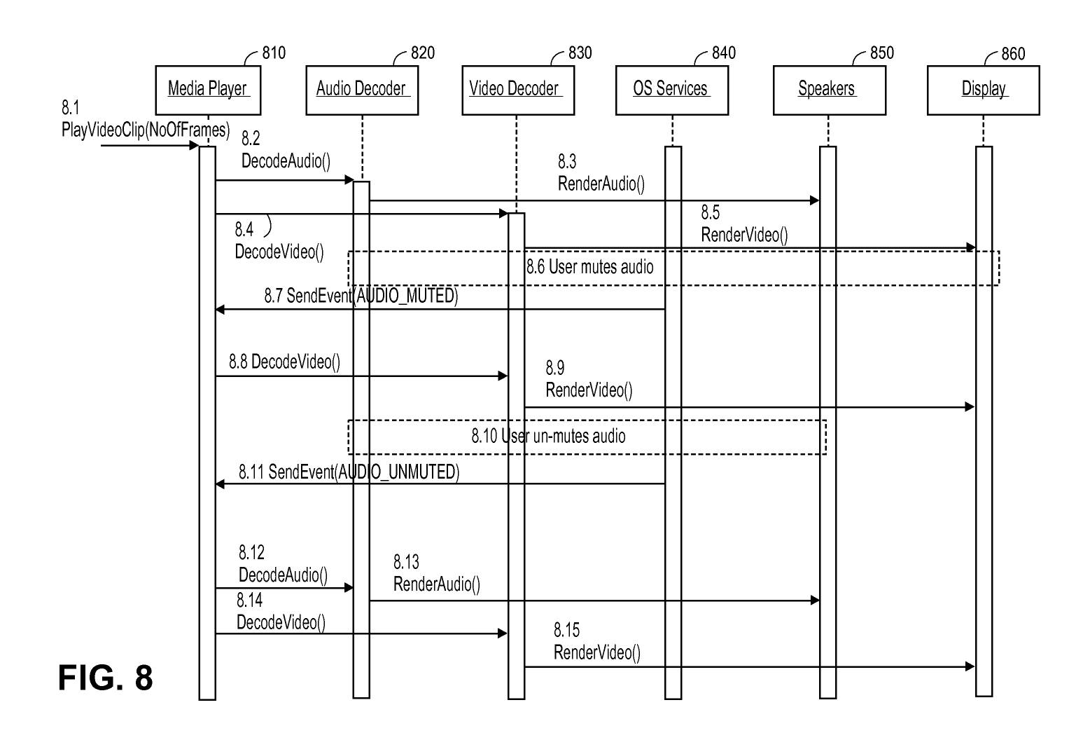

FIG. 8 is a sequence diagram showing interaction between components of the system of FIG. 1 during a playback scenario where the audio output is muted in accordance with another embodiment of the invention. In action 8.1, an input media stream is provided to media player 810 via a command PlayVideoClip(NoOfFrames). In response to receiving the video clip, media player 810 calls audio decoder 820, providing a bit stream in action 8.2. In action 8.3, audio decoder 820 decodes the bit stream and renders the audio stream output on speakers 850. In action 8.4, media player 810 calls video decoder 830, providing the video stream. In action 8.5, video decoder 830 decodes and renders the video output stream on display 860. During all of this activity when the policy is active, OS services 840 monitors for a scenario in which power consumption can be optimized. Up until this point, the normal playback scenario has been followed as no opportunities to optimize power consumption have occurred.

In action 8.6, OS services 840 identifies a scenario where the audio playback has been muted. In action 8.7, OS services 840 sends an event AUDIO_MUTED to media player 810. In response to receiving the event, media player 810 interrupts decoding of the audio stream to enter a power optimization mode. In action 8.8, media player 810 continues to send the video stream to video decoder 830 for decoding, and in action 8.9, video decoder 830 renders the output video stream on display 860. Video only playback continues until OS services 840 identifies a scenario where audio decoding is again needed.

In action 8.10, the user un-mutes the audio playback. In response to detecting this event, in action 8.11, OS services 840 sends an event AUDIO_UNMUTED to media player 810. Normal playback resumes with the video playback application focused and non-muted audio. In action 8.12, media player 810 provides the audio stream to audio decoder 820, which decodes and renders the audio stream on speakers 850 in action 8.13. In action 8.14, media player 810 sends the video stream to video decoder 830 for decoding, and in action 8.15, video decoder 830 decodes and renders the video stream on display 860.

The techniques described herein enable power savings to be achieved by recognizing special playback scenarios in which audio or video decoding can be avoided. The resultant power savings extend battery life for mobile devices without compromising the user's enjoyment of multimedia presentations.

Embodiments of the mechanisms disclosed herein may be implemented in hardware, software, firmware, or a combination of such implementation approaches. Embodiments of the invention may be implemented as computer programs executing on programmable systems comprising at least one processor, a data storage system (including volatile and non-volatile memory and/or storage elements), at least one input device, and at least one output device.

Program code may be applied to input data to perform the functions described herein and generate output information. Embodiments of the invention also include machine-accessible media containing instructions for performing the operations of the invention or containing design data, such as HDL, which defines structures, circuits, apparatuses, processors and/or system features described herein. Such embodiments may also be referred to as program products.

Such machine-accessible storage media may include, without limitation, tangible arrangements of particles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash programmable memories (FLASH), electrically erasable programmable read-only memories (EEPROMs), magnetic or optical cards, or any other type of media suitable for storing electronic instructions.

The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the mechanisms described herein are not limited in scope to any particular programming language. In any case, the language may be a compiled or interpreted language.

Presented herein are embodiments of methods and systems for optimizing power consumption during special media playback scenarios. While particular embodiments of the present invention have been shown and described, it will be obvious to those skilled in the art that numerous changes, variations and modifications can be made without departing from the scope of the appended claims. Accordingly, one of skill in the art will recognize that changes and modifications can be made without departing from the present invention in its broader aspects. The appended claims are to encompass within their scope all such changes, variations, and modifications that fall within the true scope and spirit of the present invention.

What is claimed is:

1. A computer-implemented method comprising:
identifying a scenario where decoding of a first portion of an multimedia stream can be interrupted;
interrupting the decoding of the first portion of the multimedia stream while continuing to decode a second portion of the multimedia stream.

2. The method of claim 1 wherein
the first portion is a video stream and the second portion is an audio stream; and
the scenario includes a playback application for the video stream being hidden.

3. The method of claim 1 wherein
the first portion is an audio stream and the second portion is a video stream; and
the scenario includes the audio stream being muted.

4. The method of claim 1 further comprising:
determining that the scenario has changed; and
resuming decoding of the first portion of the multimedia stream.

5. The method of claim 4 wherein resuming decoding of the first portion of the multimedia stream comprises:
identifying a first frame currently being decoded in the second portion of the multimedia stream;
identifying a second frame in the first portion of the multimedia stream, the second frame corresponding to the first frame; and
resuming rendering of the first portion of the multimedia stream with the second frame.

6. A system comprising:
at least one processor; and
a memory coupled to the at least one processor, the memory comprising instructions for performing the following:
identifying a scenario where decoding of a first portion of an multimedia stream can be interrupted;
interrupting the decoding of the first portion of the multimedia stream while continuing to decode a second portion of the multimedia stream.

7. The system of claim 6 wherein
the first portion is a video stream and the second portion is an audio stream; and
the scenario includes a playback application for the video stream being hidden.

8. The system of claim 6 wherein
the first portion is an audio stream and the second portion is a video stream; and
the scenario includes the audio stream being muted.

9. The system of claim 6 wherein the instructions further comprise instructions for performing the following:
determining that the scenario has changed; and
resuming decoding of the first portion of the multimedia stream.

10. The system of claim 9 wherein resuming decoding of the first portion of the multimedia stream comprises:
identifying a first frame currently being decoded in the second portion of the multimedia stream;
identifying a second frame in the first portion of the multimedia stream, the second frame corresponding to the first frame; and
resuming rendering of the first portion of the multimedia stream with the second frame.

11. A computer program product comprising:
a computer-readable storage medium; and
instructions in the computer-readable storage medium, wherein the instructions, when executed in a processing system, cause the processing system to perform operations comprising:
identifying a scenario where decoding of a first portion of an multimedia stream can be interrupted;
interrupting the decoding of the first portion of the multimedia stream while continuing to decode a second portion of the multimedia stream.

12. The computer program product of claim 11 wherein
the first portion is a video stream and the second portion is an audio stream; and
the scenario includes a playback application for the video stream being hidden.

13. The computer program product of claim 11 wherein
the first portion is an audio stream and the second portion is a video stream; and
the scenario includes the audio stream being muted.

14. The computer program product of claim 11 wherein the instructions further cause the processing system to perform operations comprising:
determining that the scenario has changed; and
resuming decoding of the first portion of the multimedia stream.

15. The computer program product of claim 14 wherein resuming decoding of the first portion of the multimedia stream comprises:
identifying a first frame currently being decoded in the second portion of the multimedia stream;
identifying a second frame in the first portion of the multimedia stream, the second frame corresponding to the first frame; and
resuming rendering of the first portion of the multimedia stream with the second frame.
